(19) United States
(12) Patent Application Publication
(10) Pub. No.: US 2007/0085817 A1
(43) Pub. Date: Apr. 19, 2007

(54) Method for driving active matrix liquid crystal display

(75) Inventors: Eddy(Ging-Li) Chen, Miao-Li (TW); Long-Kuan Chen, Miao-Li (TW); Sz Hsiao Chen, Miao-Li (TW); Chih-Sheng Chang, Miao-Li (TW); Wen-Chieh Liao, Miao-Li (TW); Chueh-Ju Chen, Miao-Li (TW); Tsau Hua Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/580,508

(22) Filed: Oct. 13, 2006

(30) Foreign Application Priority Data
Oct. 14, 2005 (TW) 94135973

(51) Int. Cl. G09G 3/36

(52) U.S. Cl. 345/102

(57) ABSTRACT

A method for driving a liquid crystal display (200) includes: providing a liquid crystal display having a plurality of pixel units and a backlight; dividing a frame time into a plurality of sub-frames; defining each pixel unit to have two states, namely on or off, in each of the sub-frames; defining the backlight to have a gradation luminance and two states, namely on or off, in each of the sub-frames; and synchronously controlling the state of each pixel unit, a time period of the on state of each pixel unit, the gradation luminance of the backlight, and a time period of the on state of the backlight in each of the sub-frames to make a resulting total luminous flux in each pixel unit corresponding to a gray scale of an image to be displayed in the frame time to be the same as that of other pixel units.

### FIELD OF THE INVENTION

The present invention relates to methods of driving liquid crystal displays (LCDs); and more particularly to a method for driving an active matrix type LCD, which enables a resulting total luminous flux corresponding to gray scales of images to be displayed to be uniform across plural pixels.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by many to have the potential to completely replace CRT (cathode ray tube) monitors and televisions.

FIG. 3 is an abbreviated circuit diagram of a conventional active matrix LCD. The active matrix LCD 100 includes a glass first substrate (not shown), a glass second substrate (not shown) facing the first substrate, and a liquid crystal layer (not shown) sandwiched between the first substrate and the second substrate. The first substrate includes n rows of parallel scan lines 101, and m columns of parallel data lines 102 orthogonal to the n rows of parallel scan lines 101. The first substrate also includes a plurality of thin-film transistors (TFTs) 104, which function as switching elements to drive corresponding pixel electrodes 103. Each of the TFTs 104 is positioned near a crossing of a corresponding scan line 101 and a corresponding data line 102. A gate electrode 1040 of the TFT 104 is electrically coupled to the scan line 101, and a source electrode 1041 of the TFT 104 is electrically coupled to the data line 102. Further, a drain electrode 1042 of the TFT 104 is electrically coupled to the corresponding pixel electrode 103. Each pixel electrode 103 and a respective one of common electrodes 105 cooperatively form a capacitor 107.

FIG. 4 shows three timing charts illustrating operation of the active matrix LCD 100. FIG. 4(a) illustrates a waveform diagram of voltage supplied to the gate electrode 1040 of one TFT 104. FIG. 4(b) illustrates a waveform diagram of voltage supplied to the source electrode 1041 of the TFT 104. FIG. 4(c) illustrates a waveform diagram of voltage of the pixel electrode 103 of the TFT 104.

During a first frame, i.e. a period between a time t₁ and a time t₃, a gate electrode driving device (not shown) supplies a scanning voltage V_{g} to drive the gate electrode 1040 of the TFT 104. After the TFT 104 is turned on, a source electrode driving device (not shown) supplies a gray scale voltage V_{d} to the pixel electrode 103 through the source electrode 1041 and the drain electrode 1042 of the TFT 104. Thereby, the pixel electrode 103 is charged to a voltage Vₚ₁ while the gray scale voltage V_{d} is maintained. When the time t is equal to t₂, the TFT 104 is turned off by turning off the supply of the scanning voltage V_{g}, whereupon the capacitor 107 maintains the voltage Vₚ₁ until the TFT 104 is turned on at t=t₃.

Similarly, during a second frame, when t is equal to t₃, the scanning voltage V_{g} is supplied to drive the TFT 104. The pixel electrode 103 is charged to a voltage Vₚ₂ while the gray scale voltage V_{d} is maintained. At t=t₄, the TFT 104 is turned off by turning off the supply of the scanning voltage V_{g}, whereupon the capacitor 107 maintains the voltage Vₚ₂.

In the active matrix LCD 100, the gray scale voltage V_{d} corresponds to the gray scale of each of pixels that display images. That is, if the gray scales of all the pixels are equal, then the gray scale voltages V_{d} applied to the pixels should also be equal. However, liquid crystal molecules used in the liquid crystal layer of the active matrix LCD 100 are liable to be sticky, and normal manufacturing error is liable to result in the capacitors 107 of the pixels having slightly different capacitances. Therefore, even if the gray scale voltage V_{d} provided to all the pixel electrodes 103 is the same, this does not necessarily ensure that the voltages Vₚ maintained by the capacitors 107 are all equal. That is, the luminous flux in each pixel may differ from that in other pixels. As a result, the gray scales in the pixels may be different from each other, even when equal gray scale voltages V_{d} are provided thereto. This means the active matrix LCD 100 may not be able to provide clear, even images.

It is desired to provide a method for driving an active matrix LCD which can overcome the above-described deficiencies.

### SUMMARY

A method for driving a liquid crystal display includes: providing a liquid crystal display having a plurality of pixel units and a backlight; dividing a frame time into a plurality of sub-frames; defining each pixel unit to have two states, namely on or off, in each of the sub-frames; defining the backlight to have a gradation luminance and two states, namely on or off, in each of the sub-frames; and synchronously controlling the state of each pixel unit, a time period of the on state of each pixel unit, the gradation luminance of the backlight, and a time period of the on state of the backlight in each of the sub-frames to make a resulting total luminous flux in each pixel unit corresponding to a gray scale of an image to be displayed in the frame time to be the same as that of other pixel units.

Advantages and novel features of the method will become more apparent from the following detailed description when taken in conjunction with the accompanying drawings, in which:

### BRIEF DESCRIPTION OF THE DRAWINGS

FIG. 1 is an abbreviated circuit diagram of an exemplary active matrix LCD used in carrying out a method according to an exemplary embodiment of the present invention;

FIG. 2 shows five timing charts illustrating exemplary operation of the active matrix LCD of FIG. 1;

FIG. 3 is an abbreviated circuit diagram of a conventional active matrix LCD; and

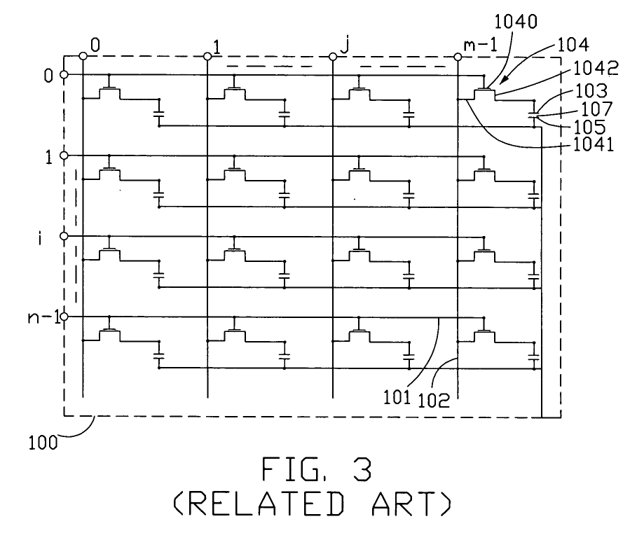

FIG. 4 shows three timing charts illustrating operation of the active matrix LCD of FIG. 3.

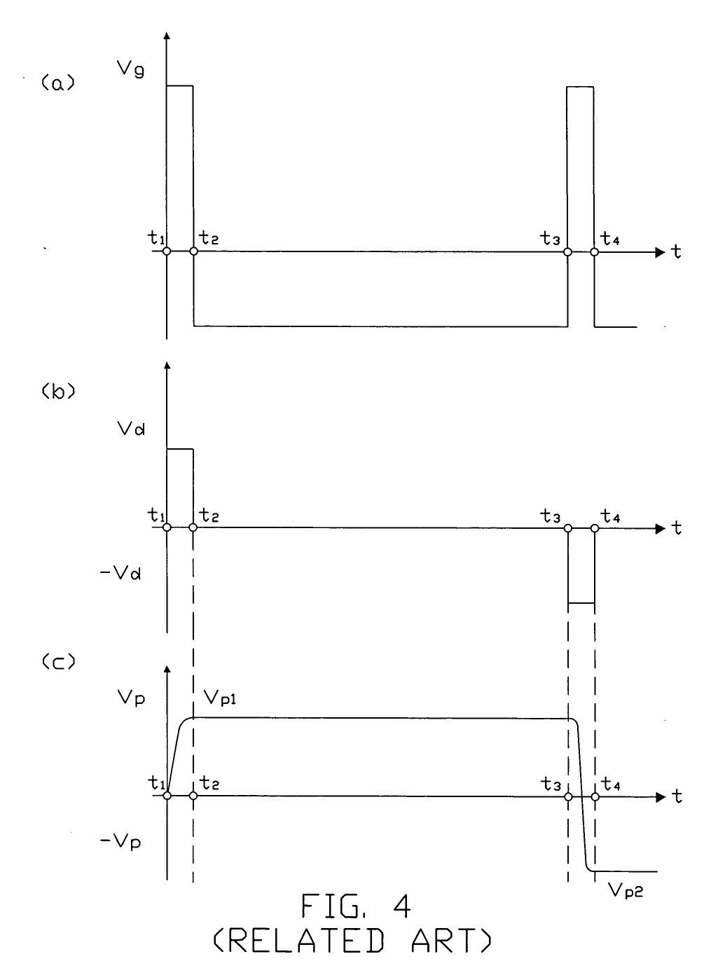

### DETAILED DESCRIPTION OF PREFERRED EMBODIMENTS

Reference will now be made to the drawings to describe preferred and exemplary embodiments of the present invention in detail.

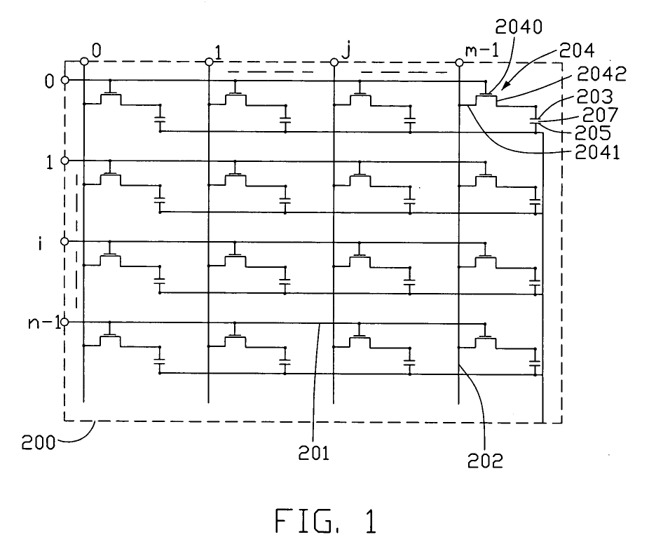

FIG. 1 is an abbreviated circuit diagram of an active matrix LCD used in carrying out a method according to an exemplary embodiment of the present invention. The active matrix LCD 200 includes a glass first substrate (not shown), a glass second substrate (not shown) facing the first substrate, a liquid crystal layer (not shown) sandwiched between the first substrate and the second substrate, and a backlight (not shown) that functions as a surface light source for illuminating the above-mentioned components of the active matrix LCD 200. The backlight typically uses an LED (light emitting diode) or a CCFL (cold cathode fluorescent lamp) as a light source, or plural LEDs or CCFLs.

The first substrate includes n rows of parallel scan lines 201 and m columns of parallel data lines 202. The data lines 202 are electrically insulated from and perpendicular to the scan lines 201. The first substrate further includes a plurality of thin-film transistors (TFTs) 204, which function as switching elements to drive respective pixel electrodes 203. Each of the TFTs 204 is positioned in the vicinity of the crossover of a corresponding scan line 201 and a corresponding data line 202. A gate electrode 2040 of the TFT 204 is electrically coupled to the scan line 201, and a source electrode 2041 of the TFT 204 is electrically coupled to the data line 202. Further, a drain electrode 2042 of the TFT 204 is electrically coupled to a corresponding pixel electrode 203. The second substrate includes a plurality of common electrodes 205 opposite to the pixel electrodes 203. In particular, the common electrodes 205 are formed on a surface of the second substrate facing the first substrate, and are made from a transparent material such as ITO (Indium-Tin Oxide) or the like. Each pixel electrode 203 and a respective common electrode 205 cooperatively form a capacitor 207. A pixel electrode 203, a common electrode 205 facing the pixel electrode 203, and liquid crystal molecules of the liquid crystal layer sandwiched between the two electrodes 203, 205 cooperatively define a single pixel unit.

An exemplary method for driving the active matrix LCD 200 includes the steps of: dividing a frame time into a plurality of sub-frames; defining each pixel unit to have two states, namely on or off, in each of the sub-frames, wherein a time period of the on state of each pixel unit may be less than, or equal to, or greater than a time period of the sub-frame; defining the backlight to have a gradation luminance and two states, namely on or off, in each of the sub-frames, wherein a time period of the on state of the backlight may be less than, or equal to, or greater than the time period of the sub-frame; and synchronously controlling the state of each pixel unit, the time period of the on state of each pixel unit, the gradation luminance of the backlight, and the time period of the on state of the backlight in each of the sub-frames to make a resulting total luminous flux in each pixel unit corresponding to a gray scale of an image to be displayed in the frame time to be the same as that of other pixel units.

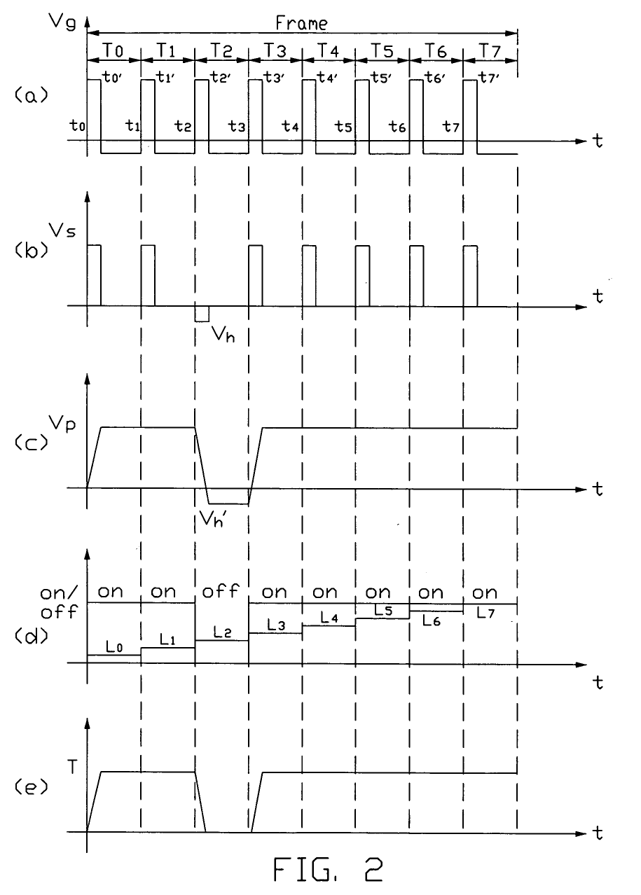

FIG. 2 shows five timing charts illustrating exemplary operation of the active matrix LCD 200. In particular, FIGS. 2(a)-2(e) illustrate voltage and light transmittance characteristics of the active matrix LCD 200 when it is driven according to the above-described exemplary driving method. FIG. 2(a) illustrates voltage waveforms of the gate electrode 2040 of one of the TFTs 204. FIG. 2(b) illustrates voltage waveforms of the source electrode 2041 of the TFT 204. FIG. 2(c) illustrates voltage waveforms of the pixel electrode 203 of the TFT 204. FIG. 2(d) illustrates a waveform of the gradation luminance of the backlight. FIG. 2(e) illustrates a waveform of light transmittance of the pixel unit of the TFT 204.

Referring to FIGS. 1 and 2, the exemplary operation of the active matrix LCD 200 is as follows. A frame is divided into x sub-frames T₀˜Tₓ₋₁, and the gradation luminance of the backlight is divided into y levels L₀˜L_{y-1}. x and y may for example be one of 8, 16, 32 or 64, corresponding to a resolution of the gray-scale voltage being 8 levels, 16 levels, 32 levels, or 64 levels. Further, x may or may not be equal to y.

In the illustrated embodiment, for example, x and y are both defined as 8. Thus a frame is divided into 8 sub-frames T₀˜T₇, and the gradation luminance of the backlight is divided into 8 levels L₀˜L₇.

During the sub-frame T₀, a gate electrode driving device (not shown) supplies a scan voltage V_{g} to drive the gate electrode 2040 of the TFT 204 at a time t₀. Thereby, the TFT 204 is turned on. In addition, a source electrode driving device (not shown) supplies a gray-scale voltage Vₛ to the pixel electrode 203 through the source electrode 2041 and the drain electrode 2042. The pixel electrode 203 is charged to a voltage Vₚ because of the gray-scale voltage Vₛ supplied. When the scan voltage V_{g} is turned off to turn off the TFT 204 at a time t_{0′}, the capacitor 207 maintains the voltage Vₚ of the pixel electrode 203. The backlight is turned on to provide light beams at the L₀ level of the gradation luminance during the sub-frame T₀. Then the pixel unit is switched from an off state to an on state by the voltage Vₚ of the pixel electrode 203.

During the sub-frame T₁, the gate electrode driving device supplies the scan voltage V_{g} to drive the gate electrode 2040 of the TFT 204 at a time t₁. Thereby, the TFT 204 is turned on. In addition, the source electrode driving device supplies the gray-scale voltage VS to the pixel electrode 203 through the source electrode 2041 and the drain electrode 2042. The pixel electrode 203 is charged to the voltage Vₚ because of the gray-scale voltage Vₛ supplied. When the scan voltage V_{g} is turned off to turn off the TFT 204 at a time t_{1′}, the capacitor 207 maintains the voltage Vₚ of the pixel electrode 203. The backlight is turned on to provide light beams at the L₁ level of the gradation luminance during the sub-frame T₁. Then the pixel unit is maintained in the on state.

During the sub-frame T₂, the gate electrode driving device supplies the scan voltage V_{g} to drive the gate electrode 2040 of the TFT 204 at a time t₂. Thereby, the TFT 204 is turned on. In addition, the source electrode driving device supplies a restoring voltage Vₕ to the pixel electrode 203 through the source electrode 2041 and the drain electrode 2042. The pixel electrode 203 is charged to a voltage V_{h′} because of the restoring voltage Vₕ supplied. When the scan voltage V_{g} is turned off to turn off the TFT 204 at a time t_{2′}, the capacitor 207 maintains the voltage V_{h′} of the pixel electrode 203. The backlight is turned on to provide light beams at the L₂ level of the gradation luminance during the sub-frame T₂. Though the backlight provides light beams during the sub-frame T₂, the pixel unit is switched from the on state to the off state by the restoring voltage V_{h′} of the pixel electrode 203.

During the sub-frame T₃, the gate electrode driving device supplies the scan voltage V_{g} to drive the gate electrode 2040 of the TFT 204 at a time t₃. Thereby, the TFT 204 is turned on. In addition, the source electrode driving device supplies the gray-scale voltage Vₛ to the pixel electrode 203 through the source electrode 2041 and the drain electrode 2042. The pixel electrode 203 is charged to the voltage Vₚ because of the gray-scale voltage Vₛ supplied. When the scan voltage V_{g} is turned off to turn off the TFT 204 at a time t_{3′}, the capacitor 207 maintains the voltage Vₚ of the pixel electrode 203. The backlight is turned on to provide light beams at the L₃ level of the gradation luminance during the sub-frame T₃. Then the pixel unit is switched from the off state to the on state by the voltage Vₚ of the pixel electrode 203.

The same kind of process continues during the sub-frame T₃, the sub-frame T₄, the sub-frame T₅, and the sub-frame T₆. Then during the sub-frame T₇, the gate electrode driving device supplies the scan voltage V_{g} to drive the gate electrode 2040 of the TFT 204 at a time t₇. Thereby, the TFT 204 is turned on. In addition, the source electrode driving device supplies the gray-scale voltage Vₛ to the pixel electrode 203 through the source electrode 2041 and the drain electrode 2042. The pixel electrode 203 is charged to the voltage Vₚ because of the gray-scale voltage Vₛ supplied. When the scan voltage V_{g} is turned off to turn off the TFT 204 at a time t_{7′}, the capacitor 207 maintains the voltage Vₚ of the pixel electrode 203. The backlight is turned on to provide light beams at the L₇ level of the gradation luminance during the sub-frame T₇. Then the pixel unit is maintained in the on state until the end of the frame.

The above-described method for driving the active matrix LCD 200 requires that the liquid crystal molecules have fast response capability. In particular, ferroelectric liquid crystal having a response time in the order of microseconds is preferred. Either of the following two types of ferroelectric liquid crystal may for example be used: surface stabilized ferroelectric liquid crystal (SSFLC), and soft mode ferroelectric liquid crystal (SMFLC).

According to the above-described method, an integral of total luminous flux (I_{F}) in each pixel unit corresponding to a gray scale of an image to be displayed can be obtained by controlling the following four parameters: the state of each pixel unit (A), the time of an on state of each pixel unit (t), the gradation luminance of the backlight (L), and the time of an on state of the backlight (T). The integral of the total luminous flux may be expressed by the following equation:
I_{F} ==∫L·T·A·tdt

In summary, each pixel unit in a sub-frame has only two states: on or off. When the pixel unit is in the off state, the driving voltage is zero. On the other hand, when the pixel unit is in the on state, only a driving voltage greater than the threshold voltage of the pixel unit is needed to turn the pixel unit on. Therefore the driving voltage need only have two states. Thus even when normal manufacturing error results in the capacitors 207 of the pixel units having different capacitances from each other, when the above-described method for driving the active matrix LCD 200 is used, all of the pixel units may have a same luminous flux corresponding to a same gray scale. That is, images displayed by the active matrix LCD 200 operating according to the exemplary driving method are clear and even.

In alternative embodiments, for example, one or several sub-frames may be used as a black insertion period Tᵣ. During the period Tᵣ, one or both of the pixel units and the backlight may be turned off. In addition, a time period divided into several sub-periods is not limited to being a frame. The dividend time period may be a period of time needed for driving a row or a column of the pixel units, or a period of time needed for driving a plurality of rows or a plurality of columns of the pixel units.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of shape, size, and arrangement of parts) within the principles of the invention to the full extent indicated by the broad general meaning of the terms in which the appended claims are expressed.

What is claimed is:

1. A method for driving a liquid crystal display, comprising:
providing a liquid crystal display comprising a plurality of pixel units and a backlight;
dividing a frame time into a plurality of sub-frames;
defining each pixel unit to have two states, namely on or off, in each of the sub-frames;
defining the backlight to have a gradation luminance and two states, namely on or off, in each of the sub-frames; and
synchronously controlling the state of each pixel unit, a time period of the on state of each pixel unit, the gradation luminance of the backlight, and a time period of the on state of the backlight in each of the sub-frames to make a resulting total luminous flux in each pixel unit corresponding to a gray scale of an image to be displayed in the frame time to be the same as that of other pixel units.

2. The method as claimed in claim 1, wherein an integral of the total luminous flux in each pixel unit is expressed by the equation: I_{F}=∫L·T·A·tdt, wherein, I_{F} is the integral of total luminous flux in each pixel unit, A is the state of each pixel unit, t is the time period of the on state of each pixel unit, L is the gradation luminance of the backlight, and T is the time period of the on state of the backlight.

3. The method as claimed in claim 1, wherein the backlight comprises a cold cathode fluorescent lamp.

4. The method as claimed in claim 1, wherein the backlight comprises a light emitting diode.

5. The method as claimed in claim 1, wherein a resolution of the gray-scale voltage is 8 levels, 16 levels, 32 levels, or 64 levels.

6. The method as claimed in claim 1, wherein at least one of the sub-frames is a black insertion period.

7. The method as claimed in claim 6, wherein the backlight is turned off during the black insertion period.

8. The method as claimed in claim 6, wherein the pixel unit is in an off state during the black insertion period.

9. The method as claimed in claim 1, wherein the liquid crystal display further comprises surface stabilized ferroelectric liquid crystal.

10. The method as claimed in claim 1, wherein the liquid crystal display further comprises soft mode ferroelectric liquid crystal.
